(19) United States
(12) Patent Application Publication
(10) Pub. No.: US 2009/0094049 A1
(43) Pub. Date: Apr. 9, 2009

(54) MACHINE-IMPLEMENTED ITEM EXCHANGE METHOD

(76) Inventors: Wen-Kai LI, Tainan County (TW); Shih-Heng CHIN, Tainan County (TW)

Correspondence Address: LADAS & PARRY LLP, 224 SOUTH MICHIGAN AVENUE, SUITE 1600, CHICAGO, IL, 60604, US

(21) Appl. No.: 12/234,794

(22) Filed: Sep. 22, 2008

(30) Foreign Application Priority Data
Oct. 3, 2007 (TW) 096137067

(51) Int. Cl. G06Q 30/00

(52) U.S. Cl. 705/1

(57) ABSTRACT

A machine-implemented item exchange method includes the steps of: (a) based on at least one value that has been set by a first member on at least one item possessed by the first member, and at least one value that has been set by the first member on at least one item possessed by a second member, determining in accordance with an exchange rule and on behalf of the first member a correlation indicative of willingness of the first member to exchange an item possessed thereby for an item possessed by the second member; and (b) in accordance with the correlation determined in step (a), performing item matching so as to generate a match list.

### CROSS-REFERENCE TO RELATED APPLICATION

This application claims priority of Taiwanese application no. 096137067, filed on Oct. 3, 2007.

### BACKGROUND OF THE INVENTION

1. Field of the Invention

This invention relates to a machine-implemented item exchange method, more particularly to a machine-implemented item exchange method capable of increasing a success rate of item exchanges.

2. Description of the Related Art

Due to environmental concerns, many online systems for exchanging used items have already been developed. The conventional online item exchange system allows a member to exchange items possessed thereby and no longer needed for items possessed by other members. Reuse of the items economizes consumption costs, in addition to reducing the impact of consumption on the environment.

However, the conventional online item exchange system only enables members to upload and browse items. After one member finds an item possessed by another member that the one member is willing to exchange for an item possessed thereby, the one member must make many inquiries (via email or instant message) in order to negotiate an actual exchange. The many inquiries needed are time consuming, and the resulting exchanges are often unsatisfactory and necessitate further exchanges at the expense of finding other items suitable for exchange. The conventional item exchange system thus has a low rate of successful item exchanges.

There is thus a need to reduce the number of inquiries necessary to negotiate an exchange of items so as to conserve time and increase the success rate of item exchanges.

### SUMMARY OF THE INVENTION

Therefore, the object of the present invention is to provide a machine-implemented item exchange method that can overcome the above drawbacks of the prior art.

According to the present invention, there is provided a machine-implemented item exchange method. The machine-implemented item exchange method comprises the steps of:
(a) based on at least one value that has been set by a first member on at least one item possessed by the first member, and at least one value that has been set by the first member on at least one item possessed by a second member, determining in accordance with an exchange rule and on behalf of the first member a correlation indicative of willingness of the first member to exchange an item possessed thereby for an item possessed by the second member; and
(b) in accordance with the correlation determined in step (a), performing item matching so as to generate a match list.

The match list generated in accordance with the machine-implemented item exchange method of the present invention can reduce the number of inquiries necessary for negotiating an exchange, save time, and increase the success rate of item exchanges.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic system block diagram of an online item exchange system capable of realizing the preferred embodiment of a machine-implemented item exchange method according to the present invention;

FIG. 2 is a flow chart of the preferred embodiment of the machine-implemented item exchange method;

FIG. 3a is a schematic diagram showing a correlation among items possessed by first, second, and third members determined in accordance with the method of the preferred embodiment; and

FIG. 3b is a schematic diagram illustrating an exchange flow of the items of the first, second, and third members in accordance with the method of the preferred embodiment.

### DETAILED DESCRIPTION OF THE PREFERRED EMBODIMENT

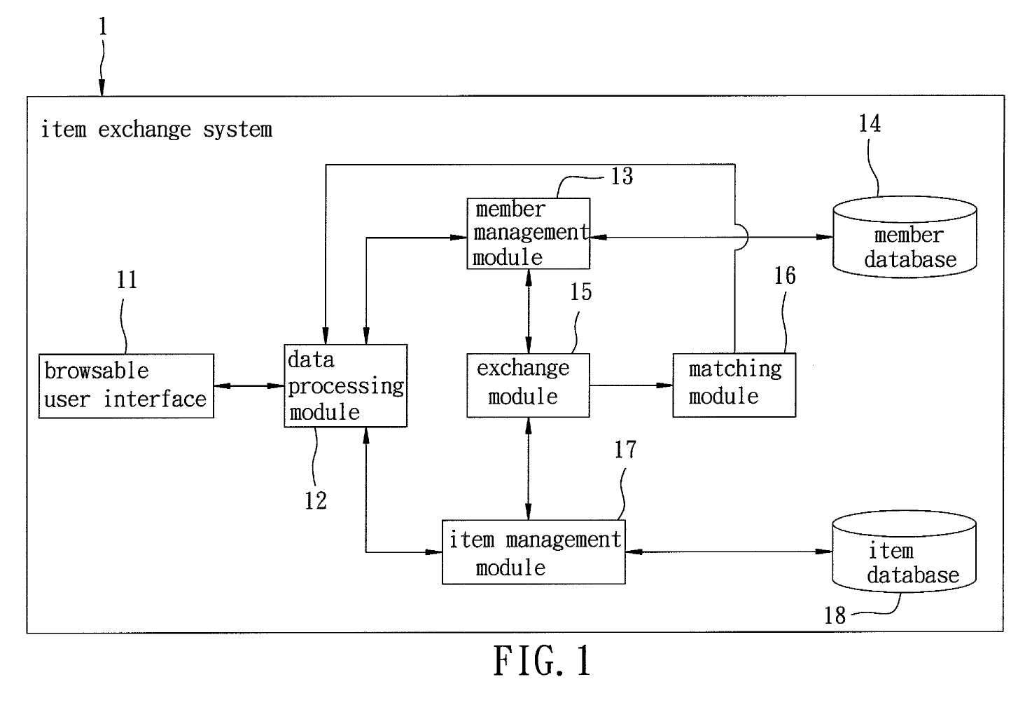

FIG. 1 illustrates an online item exchange system 1 capable of realizing the preferred embodiment of the machine-implemented item exchange method of the present invention. The item exchange system 1 comprises a browsable user interface 11, a data processing module 12, a member management module 13, a member database 14, an exchange module 15, a matching module 16, an item management module 17, and an item database 18.

The item exchange system 1 has a plurality of members. The item exchange system 1 enables each of the members, after logging into the item exchange system 1, to perform uploading of item information, browsing of items, editing of the item information, and exchanging of items through the browsable user interface 11.

The browsable user interface 11 enables the members to edit their own member information. After the member edits his/her own member information, the member information is transmitted to the data processing module 12 for format conversion, and is then transmitted to the member management module 13. Through the member management module 13, the member information is stored in the member database 14. The aforesaid member information includes contact information, such as a telephone number or an email address.

The member management module 13 is also capable of accessing the member information of the member from the member database 14. After the member management module 13 accesses the member information, the member information is transmitted to the data processing module 12 for format conversion, and is then provided to the member through the browsable user interface 11.

The browsable user interface 11 also enables the member to upload information of at least one item possessed thereby to the item exchange system 1, and to edit item information. After the member edits the item information, the item information is transmitted to the data processing module 12 for format conversion, and is then transmitted to the item management module 17. Through the item management module 17, the item information is stored in the item database 18.

The aforesaid item information includes an item status. The item status of each of the items in the item database 18 is one of the following: an initial status, a self-valued status, a match candidate status, a matched status, a closed status, and a delete status. When information of the item is first uploaded to the item exchange system 1, the status of the item is the closed status, and other members cannot browse the item. The member that possesses the item must change the status of the item from the closed status to the initial status in order to allow other members to browse the item.

The item management module 17 is also capable of accessing the item information from the item database 18. After the item management module 17 accesses the item information, the item information is transmitted to the data processing module 12 for format conversion, and is then provided to the members through the browsable user interface 11.

The exchange module 15 determines in accordance with an exchange rule and on behalf of the member a correlation indicative of willingness of the member to exchange an item possessed thereby for an item possessed by another member. The matching module 16 performs item matching in accordance with the correlation determined by the exchange module 15 so as to generate a match list.

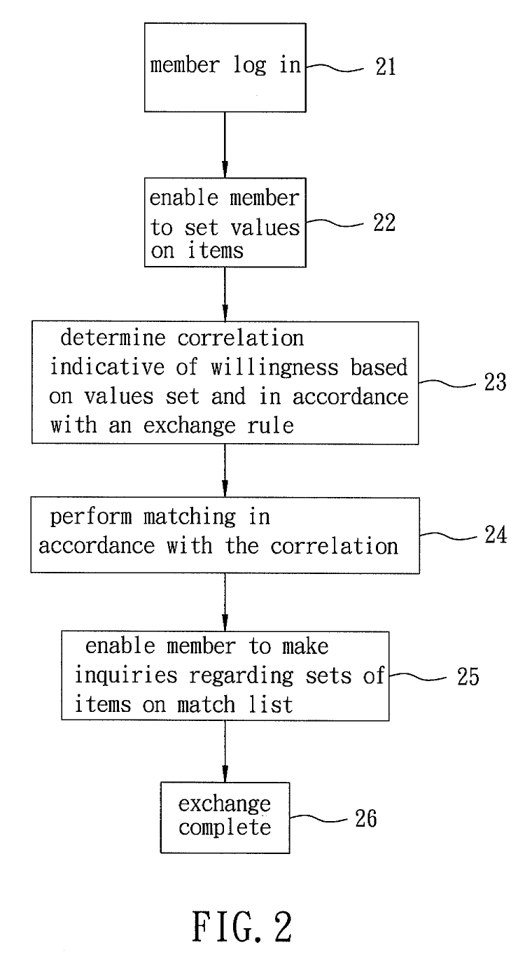

Referring to FIG. 2, a preferred embodiment of the machine-implemented item exchange method according to the present invention is shown to comprise the following steps:

In step 21, the member logs into the item exchange system 1. In step 22, through the browsable user interface 11, the member browses the items possessed thereby as well as the items possessed by other members. If the member is willing to exchange an item possessed thereby for an item possessed by another member, then in step 22, the member, through the browsable user interface 11, sets a value on each of the items. When the member sets a value on the item possessed thereby, the status of the item changes from the initial status to the self-valued status. If other members set a value on the item possessed by the member, the status of the item changes from the self-valued status to the match candidate status. Each of the values set on the item is included in the item information. Whenever the item information is thus edited, the item information is stored in the item database 18 through the item management module 17.

It is worth noting that, the browsable user interface 11 can also enable the member to sort the items possessed thereby. In accordance with a sort result, the browsable user interface 11 can automatically generate corresponding values to be set on the items. In addition, the browsable user interface 11 can provide the member with the ability to select items possessed by another member that the member is willing to exchange for the items possessed thereby. Subsequently, in accordance with values that have been set by the member on the items possessed thereby (which can be either the aforesaid values generated through the browsable user interface 11 or values determined by the member) and the items possessed by the other member that have been selected for exchange, the browsable user interface 11 can generate values to be set on the items possessed by the other member.

For convenience, the following example involves two members (that is, a first member and a second member), from which exchange flows among a plurality of members can be deduced. Table 1 shows values set by the first member on items possessed thereby, and values set by the second member on items possessed by the first member. Table 2 shows values set by the second member on items possessed thereby, and values set by the first member on items possessed by the second member. The “X” indicates that a value has not yet been set.

TABLE 1
Values set on items possessed by the first member

| Items | Value set by 1^{st} member | Value set by 2^{nd} member |
|---|---|---|
| A1 | 10 | 6 |
| A2 | 13 | X |
| A3 | 20 | 19 |
| A4 | 21 | 70 |
| A5 | 5 | 8 |
| A6 | 60 | 23 |

TABLE 2
Values set on items possessed by the second member

| Item | Value set by 2^{nd} member | Value set by 1^{st} member |
|---|---|---|
| B1 | 33 | 11 |
| B2 | 53 | 63 |
| B3 | 8 | X |
| B4 | 22 | 9 |
| B5 | 7 | 10 |
| B6 | 90 | 57 |

In step 23, the exchange module 15, based on the values set by the first member on the items possessed thereby (as shown in Table 1, in the ‘value set by 1^{st} member’ column) and the values set by the first member on items possessed by the second member (as shown in Table 2, in the ‘values set by 1^{st} member’ column), determines in accordance with the exchange rule and on behalf of the first member a correlation indicative of willingness of the first member to exchange an item possessed thereby for an item possessed by the second member. Likewise, the exchange module 15, based on the values set by the second member on the items possessed thereby (as shown in Table 2, in the ‘value set by 2nd member’ column) and the values set by the second member on items possessed by the first member (as shown in Table 1, in the ‘values set by 2nd member’), determines in accordance with the exchange rule and on behalf of the second member a correlation indicative of willingness of the second member to exchange an item possessed thereby for an item possessed by the first member.

In this embodiment, the exchange rule is: if the value set by a member on an item possessed thereby is not greater than the value set on an item possessed by another member, then the correlation is indicative of the willingness of the member to exchange the item possessed thereby for the item possessed by the another member.

Table 3 shows the items possessed by the first member and the items possessed by the second member between which the correlation indicative of willingness of the first member to exchange the items possessed thereby with the items possessed by the second member has been determined on behalf of the first member. Table 4 shows the items possessed by the second member and the items possessed by the first member between which the correlation indicative of willingness of the second member to exchange the items possessed thereby with the items possessed by the first member has been determined on the behalf of the second member.

TABLE 3

| Item possessed | Item(s) possessed by 2nd member that 1st member |
|---|---|
| by 1^{st} member | is willing to exchange with 2nd member |
| A1 | B1, B2, B5, B6 |
| A2 | B2, B6 |
| A3 | B2, B6 |
| A4 | B2, B6 |
| A5 | B1, B2, B4, B5, B6 |
| A6 | B2 |

TABLE 4

| Item possessed by | Item(s) possessed by 1^{st} member that 2^{nd} member |
|---|---|
| 2^{nd} member | is willing to exchange with 1^{st} member |
| B1 | A4 |
| B2 | A4 |
| B3 | A3, A4, A5, A6 |
| B4 | A4, A6 |
| B5 | A3, A4, A5, A6 |
| B6 | None found |

In step 24, the matching module 16, in accordance with the correlations determined in step 23, generates the match list including at least one set of matched items. Each set of matched items includes a first item possessed by the first member and correlated to a second item that is possessed by the second member and that the first member is willing to exchange with the first item, and the second item that the second member is willing to exchange for the first item.

Referring to Table 5, the match list generated in accordance with the above example shows a first item A4 possessed by the first member and correlated to a second item B2 that is possessed by the second member and that the first member is willing to exchange with the first item A4, and the second item B2 that the second member is willing to exchange for the first item A4. Items A4 and B2 thus form a set of matched items. Similarly, items A5 and B5 also form a set of matched items. The status of the items A4, A5, B2, B5 then changes from the match candidate status to the matched status. The sets of matched items generated by the matching module 16 are transmitted to the data processing module 12 for format conversion, and are then provided to the first and second members through the browsable user interface 11.

TABLE 5
Match list
A4&B2
A5&B5

In steps 25-26, the first and second members, through the browsable user interface 11, exchange inquiries regarding the sets of matched items on the match list for negotiating an actual exchange. When the first and second members agree to exchange items, the member administration module 13 accesses the member contact information of the first and second members from the member information database 14 and provides each of the first and second members with the contact information of the other. The status of the items in the sets of matched items then changes from the matched status to the closed status. Consequently, other members can no longer browse the items, and thus there is no superfluous setting of values and exchanging of inquiries. After the items have been exchanged, the status of the items changes from the closed status to the delete status. The items can then be deleted from the item exchange system 1 either manually or automatically through the item management module 17.

Based on what is shown in Tables 3, 4 and 5, it may be understood that negotiation of an exchange based solely on the willingness of the first member to exchange an item possessed thereby with an item possessed by the second member would demand no more than sixteen inquiries on behalf of the first member. Similarly, negotiation of an exchange based solely on the willingness of the second member to exchange an item possessed thereby with an item possessed by the first member would demand no more than twelve inquiries on behalf of the second member. However, if negotiation of an exchange is based on the match list, no more than two inquiries must be made on the behalves of the first and second members.

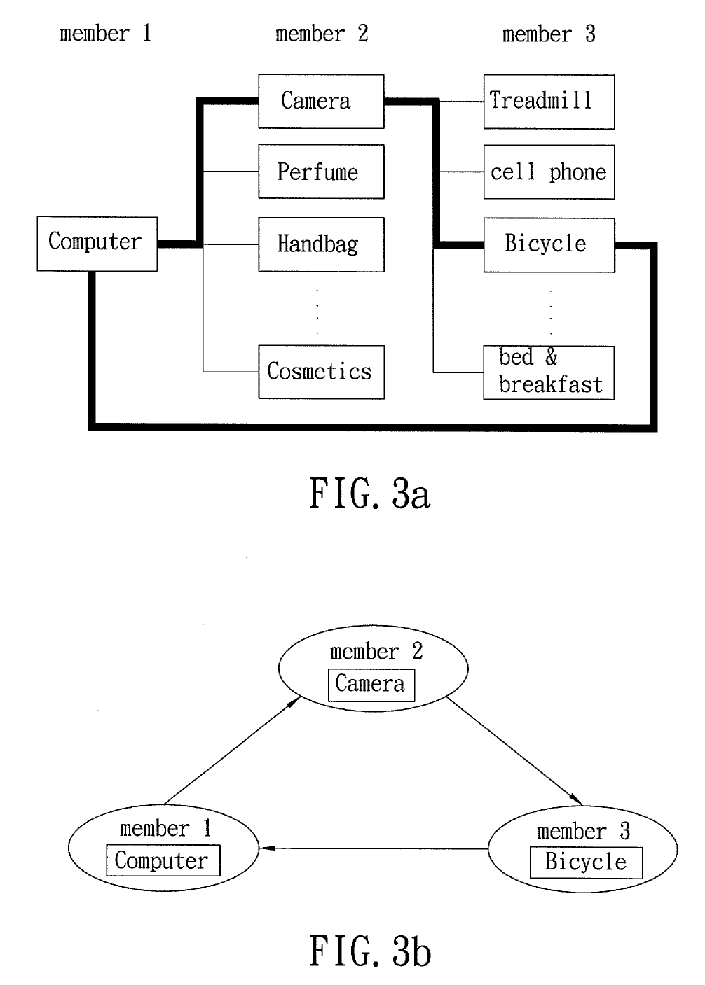

The machine-implemented item exchange method of this embodiment can be performed under conditions involving two or more members. For example, when the exchange module 15, in accordance with the exchange rule, has determined that the first member is willing to exchange a computer possessed thereby for a camera possessed by the second member, that the second member is willing to exchange the camera possessed thereby for a bicycle possessed by a third member, and that the third member is willing to exchange the bicycle possessed thereby for the computer possessed by the first member, then the matching module 15 generates a match list that includes a string of matched items, as shown in FIGS. 3a and 3b.

In sum, the exchange module 15 and the matching module 16 generate a match list in accordance with the machine-implemented item exchange method of the present invention that reduces the number of inquiries necessary for negotiating an exchange, saves time, and increases the success rate of item exchanges.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A machine-implemented item exchange method, comprising the steps of:
(c) based on at least one value that has been set by a first member on at least one item possessed by the first member, and at least one value that has been set by the first member on at least one item possessed by a second member, determining in accordance with an exchange rule and on behalf of the first member a correlation indicative of willingness of the first member to exchange an item possessed thereby for an item possessed by the second member; and
(d) in accordance with the correlation determined in step (a), performing item matching so as to generate a match list.

2. The machine-implemented item exchange method as claimed in claim 1, wherein said exchange rule is: if the value set by a member on an item possessed thereby is not greater than the value set on an item possessed by another member, then the correlation is indicative of the willingness of said member to exchange the item possessed thereby for the item possessed by said another member.

3. The machine-implemented item exchange method as claimed in claim 2, further comprising, between steps (a) and (b), the step of:
(c) based on a value that has been set by the second member on an item possessed by the second member, and a value that has been set by the second member on the item possessed by the first member, determining in accordance with the exchange rule and on behalf of the second member a correlation indicative of willingness of the second member to exchange an item possessed thereby for the item possessed by the first member;
wherein, in step (b), item matching is performed in accordance with the correlations determined in steps (a) and (c) so as to generate the match list.

4. The machine-implemented item exchange method as claimed in claim 3, wherein said match list includes at least one set of matched items.

5. The machine-implemented item exchange method as claimed in claim 4, wherein a set of matched items includes a first item possessed by the first member and correlated to a second item that is possessed by the second member and that the first member is willing to exchange with the first item, and the second item that the second member is willing to exchange for the first item.

6. The machine-implemented item exchange method as claimed in claim 4, further comprising, prior to step (a), the steps of:
(d) providing a browsable user interface for enabling each of the first and second members to browse the items possessed thereby as well as the items possessed by other members; and
(e) through the browsable user interface, enabling each of the first and second members to set values on the items browsed thereby.

7. The machine-implemented item exchange method as claimed in claim 6, further comprising, after step (b), the step of:
(f) through the browsable user interface, enabling the first and second members to exchange inquiries regarding one set of the matched items on said match list for negotiating an actual exchange.

8. The machine-implemented item exchange method as claimed in claim 2, wherein, in step (b), the match list that is generated includes a string of matched items when it is determined that the first member is willing to exchange an item possessed thereby for an item possessed by the second member, that the second member is willing to exchange the item possessed thereby for at least one item possessed by at least one third member, and that said at least one third member is willing to exchange said at least one item possessed thereby for the item possessed by the first member.

9. The machine-implemented item exchange method as claimed in claim 2, further comprising, prior to step (a), the steps of:
(g) providing a browsable user interface for enabling the first member to set the values for the items possessed thereby;
(h) through the browsable user interface, enabling the first member to select an item possessed by the second member for an exchange; and
(i) in accordance with the values set in step (g) and the item selected for exchange in step (k), generating a value for the item possessed by the second member.
